(19) United States
(12) Patent Application Publication
(10) Pub. No.: US 2024/0400043 A1
(43) Pub. Date: Dec. 5, 2024

(54) METHOD FOR SHARING INFORMATION ON AUTONOMOUS MOVING VEHICLE AND CONTROLLING AUTONOMOUS MOVING VEHICLE, AND SYSTEM THEREFOR

(71) Applicant: TELECONS CO., LTD., Seoul (KR)

(72) Inventors: Seok Kyu LEE, Yongin-si, Gyeonggi-do (KR); Sun Wook HWANG, Seoul (KR); Hong Jong SONG, Anyang-si, Gyeonggi-do (KR); Young Soo DO, Anyang-si, Gyeonggi-do (KR)

(21) Appl. No.: 18/687,995

(22) PCT Filed: Aug. 30, 2022
(86) PCT No.: PCT/KR2022/012955

§ 371 Date: Feb. 29, 2024

(30) Foreign Application Priority Data
Aug. 31, 2021 (KR) 10-2021-0115515

(51) Int. Cl. B60W 30/09; G05D 1/225; G05D 1/43; G06T 7/70; G06V 20/58; G07C 5/00

(52) U.S. Cl. CPC B60W 30/09; G05D 1/225; G05D 1/43; G06T 7/70; G06V 20/58; G07C 5/008; B60W 2556/45

(57) ABSTRACT

An information sharing and controlling method of an autonomous mobile vehicle according to an exemplary embodiment of the present invention includes receiving autonomous mobile vehicle information including information about a first autonomous mobile vehicle which moves toward a destination and a movement route of the first autonomous mobile vehicle, receiving an information request signal which includes information about a location of a second autonomous mobile vehicle and requests the information of the second autonomous mobile vehicle from an external terminal, and transmitting control information including information about the first autonomous mobile vehicle and information for controlling the first autonomous mobile vehicle to the external terminal when the second autonomous mobile vehicle corresponds to the first autonomous mobile vehicle.

### TECHNICAL FIELD

The present invention relates to a method and a system for sharing information between an autonomous mobile vehicle and people and providing means for controlling the autonomous mobile vehicle to people.

### BACKGROUND ART

As a technology for autonomous mobility of vehicles develops, predictions are increasing that an era of autonomous driving by which vehicles make their own decisions and move will arrive soon. That is, it is predicted that objects, such as robots or vehicles will make decisions and act on their own through communication with surrounding environments to come closer to people's lives in the future.

Generally, element technologies for autonomous mobile vehicles, such as robots, vehicles, or drones broadly span four areas. Four areas include a cognitive technology, a decision-making technology, a vehicle movement control technology, and a human computer interface (HCl). Here, the most important item that confirms autonomous will is the decision-making technology. The decision-making of autonomous mobile vehicles involves artificial intelligence (AI) technologies, such as probabilistic methods and learning/non-learning-based algorithms and with the recent development of artificial intelligence technologies, the fundamental technologies for autonomous movement have advanced dramatically.

However, the reality is that there has been no efficient means of communication between autonomous mobile vehicles and people coexisting with them and interest is increasing in increasing the possibility of coexistence by providing efficient means of communication therebetween.

Therefore, there is an emerging need for methods and systems that provide means for sharing information between autonomous mobile vehicles and people and controlling the autonomous mobile vehicles.

### DISCLOSURE

### Technical Problem

In order to solve the above-described problems, an object of the present invention is to provide a method and a system for efficiently sharing information of an autonomous mobile vehicle using a platform for sharing information between the autonomous mobile vehicle and people.

Further, an object of the present invention is to provide a method and a system for allowing people to control an autonomous mobile vehicle, by going further than sharing information between the autonomous mobile vehicle and people.

### Technical Solution

In order to achieve the above-described objects, an information sharing and controlling method of an autonomous mobile vehicle according to an exemplary embodiment of the present invention includes receiving autonomous mobile vehicle information including information about a first autonomous mobile vehicle which moves toward a destination and information about a movement route of the first autonomous mobile vehicle; receiving an information request signal which includes information about a location of a second autonomous mobile vehicle and requests the information of the second autonomous mobile vehicle from an external terminal; and transmitting control information including information about the first autonomous mobile vehicle and information for controlling the first autonomous mobile vehicle to the external terminal when the second autonomous mobile vehicle corresponds to the first autonomous mobile vehicle.

Desirably, the external terminal may control the first autonomous mobile vehicle while communicating with the first autonomous mobile vehicle using the control information.

Desirably, when the external terminal is a portable smart device, the external terminal calculates a location of the second autonomous mobile vehicle displayed on a camera application to generate the information request signal.

Desirably, before the receiving of the information request signal, the method further includes receiving registration information including information about a management area and a necessary authority from the external terminal, and in the transmitting of control information, the management area, the location of the first autonomous mobile vehicle, and the location of the second autonomous mobile vehicle are compared to determine whether the second autonomous mobile vehicle corresponds to the first autonomous mobile vehicle.

Desirably, the autonomous mobile vehicle information may include movement route, a current location, operator information, and information for controlling the operation of the first autonomous mobile vehicle.

Desirably, the method may further include receiving movement information including information of a movement route, a current location, and speed from a predetermined user; and transmitting a control command to control the first autonomous mobile vehicle to reduce a collision possibility of the user and the first autonomous mobile vehicle information in response to the movement information.

Desirably, the method may further include receiving avoidance information including information about an avoidance area that the first autonomous mobile vehicle must avoid, from the external terminal; and transmitting a control command to control the first autonomous mobile vehicle to avoid the avoidance area in response to the avoidance information.

Further, in order to achieve the above-described objects, an information sharing and controlling system of an autonomous mobile vehicle according to an exemplary embodiment of the present invention includes a receiving unit which receives autonomous mobile vehicle information including information about a first autonomous mobile vehicle which moves toward a destination and information about a movement route of the first autonomous mobile vehicle and receives an information request signal which includes information about the location of a second autonomous mobile vehicle and requests information of the second autonomous mobile vehicle from the external terminal; a determining unit which determines whether the second autonomous mobile vehicle corresponds to the first autonomous mobile vehicle; and a transmitting unit which transmits control information including information about the first autonomous mobile vehicle and information for controlling the first autonomous mobile vehicle to the external terminal when the second autonomous mobile vehicle corresponds to the first autonomous mobile vehicle.

Desirably, the external terminal may control the first autonomous mobile vehicle while communicating with the first autonomous mobile vehicle using the control information.

Desirably, when the external terminal is a portable smart device, the external terminal calculates a location of the second autonomous mobile vehicle displayed on a camera application to generate the information request signal.

### Advantageous Effects

According to the present invention, information of the autonomous mobile vehicle may be efficiently shared using a platform for sharing information between the autonomous mobile vehicle and people.

Further, according to the present invention, people may efficiently control an autonomous mobile vehicle, by going further than sharing information between the autonomous mobile vehicle and people.

### DESCRIPTION OF DRAWINGS

FIG. 1 is a flowchart for explaining an information sharing and controlling method of an autonomous mobile vehicle according to an exemplary embodiment of the present invention.

FIG. 2 is a flowchart for explaining an information sharing and controlling method of an autonomous mobile vehicle according to another exemplary embodiment of the present invention.

FIG. 3 is a flowchart for explaining an information sharing and controlling method of an autonomous mobile vehicle according to still another exemplary embodiment of the present invention.

FIG. 4 is a view for explaining a relationship among an autonomous mobile vehicle, an external terminal, and a manager according to an exemplary embodiment of the present invention.

FIG. 5 is a block diagram illustrating an information sharing and controlling system of an autonomous mobile vehicle according to an exemplary embodiment of the present invention.

### BEST MODE

Those skilled in the art may make various modifications to the present invention and the present invention may have various exemplary embodiments thereof, and thus specific exemplary embodiments will be described in detail with reference to the drawings. However, it should be understood that the present invention is not limited to the specific embodiments, but includes all changes, equivalents, or alternatives which are included in the spirit and technical scope of the present invention. In the description of respective drawings, similar reference numerals designate similar elements.

Terms such as first, second, A, or B may be used to describe various components, but the components should not be limited by the above terms. The above terms are used only to distinguish one component from the other component. For example, without departing from the scope of the present invention, a first component may be referred to as a second component, and similarly, a second component may be referred to as a first component. A term of and/or includes a combination of a plurality of related elements or any one of the plurality of related elements.

It should be understood that, when it is described that an element is “coupled” or “connected” to another element, the element may be directly coupled or directly connected to the other element or coupled or connected to the other element through a third element. In contrast, when it is described that an element is “directly coupled” or “directly connected” to another element, it should be understood that no element is present therebetween.

Terms used in the present application are used only to describe a specific exemplary embodiment, but are not intended to limit the present invention. A singular form may include a plural form if there is no clearly opposite meaning in the context. In the present application, it should be understood that the term “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

In the specification and the claim, unless explicitly described to the contrary, the word “comprise” and variations such as “comprises” or “comprising”, will be understood to imply the inclusion of status elements but not the exclusion of any other elements.

Hereinafter, the present invention will be described with reference to the accompanying drawings.

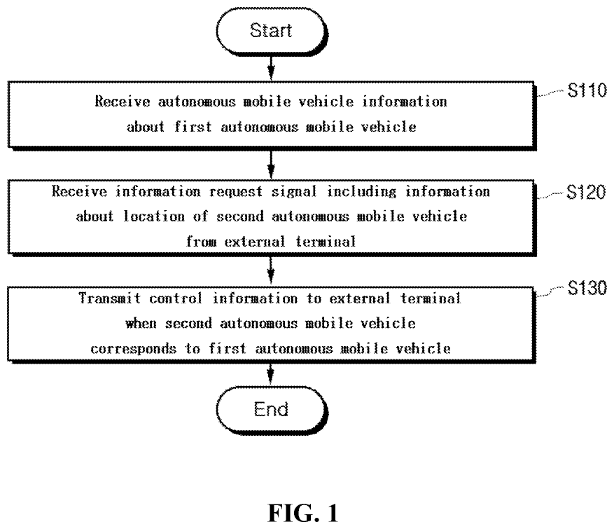

FIG. 1 is a flowchart for explaining an information sharing and controlling method of an autonomous mobile vehicle according to an exemplary embodiment of the present invention.

In step S110, an information sharing and controlling system receives autonomous mobile vehicle information including information about a first autonomous mobile vehicle which moves toward a destination and information about a movement route of the first autonomous mobile vehicle.

Here, the first autonomous mobile vehicle may include all types of mobile vehicles which move by their own decision, such as robots, vehicles and drones and the information sharing and controlling system may directly receive autonomous mobile vehicle information from an owner of the first autonomous mobile vehicle or the first autonomous mobile vehicle.

For example, it is assumed that the first autonomous mobile vehicle is an autonomous mobile vehicle which delivers parcels. The information sharing and controlling system may receive autonomous mobile vehicle information input by a parcel company which delivers parcels using the OPEN API. Alternatively, the information sharing and controlling system may receive autonomous mobile vehicle information which is input using the OPEN API as the first autonomous mobile vehicle which moves by a command of the parcel company starts directly delivering the parcels.

According to another exemplary embodiment, the autonomous mobile vehicle information may include movement route, a current location, operator information, and information for controlling the operation of the first autonomous mobile vehicle.

At this time, the movement route refers to a route which is input in advance to move the first autonomous mobile vehicle, the current location refers to a coordinate of a place where the first autonomous mobile vehicle is currently located, the operator information refers to a manager or a business entity which operates the first autonomous mobile vehicle, and the information for controlling the operation refers to API information for controlling the first autonomous mobile vehicle to be operated, stop, or detour.

Here, the information sharing and controlling system may receive information of a current location or movement route changed according to a predetermined time interval or upon the request, from the first autonomous mobile vehicle.

In step S120, the information sharing and controlling system receives an information request signal which includes information about a location of the second autonomous mobile vehicle and requests information of the second autonomous mobile vehicle, from the external terminal.

Here, the external terminal may be a smart device (a smart phone, a tablet, or the like) which is capable of performing wired or wireless communication and a computing device, such as a notebook computer or a desktop computer and may be registered in advance in the information sharing and controlling system. Further, the external terminal may be operated by people who need to share information with the autonomous mobile vehicle and control the autonomous mobile vehicle, such as policemen, managers or users of specific facilities/complexes, and owners of private lands.

Further, the information sharing and controlling system may receive an information request signal which includes information about a location of the second autonomous mobile vehicle and requests information of the second autonomous mobile vehicle, from the external terminal.

At this time, the external terminal may acquire information about the location of the second autonomous mobile vehicle using various methods.

For example, the external terminal may calculate the location of the second autonomous mobile vehicle based on a location measured using a GPS sensor, a distance sensor, and a compass sensor and a detailed description thereof will be specifically explained in the following exemplary embodiments.

According to another exemplary embodiment, when the external terminal is a portable smart device, the external terminal calculates the location of the second autonomous mobile vehicle displayed on a camera application to generate the information request signal.

At this time, the camera application may be an application which is separately produced to determine the location of the autonomous mobile vehicle and the specific details are as follows.

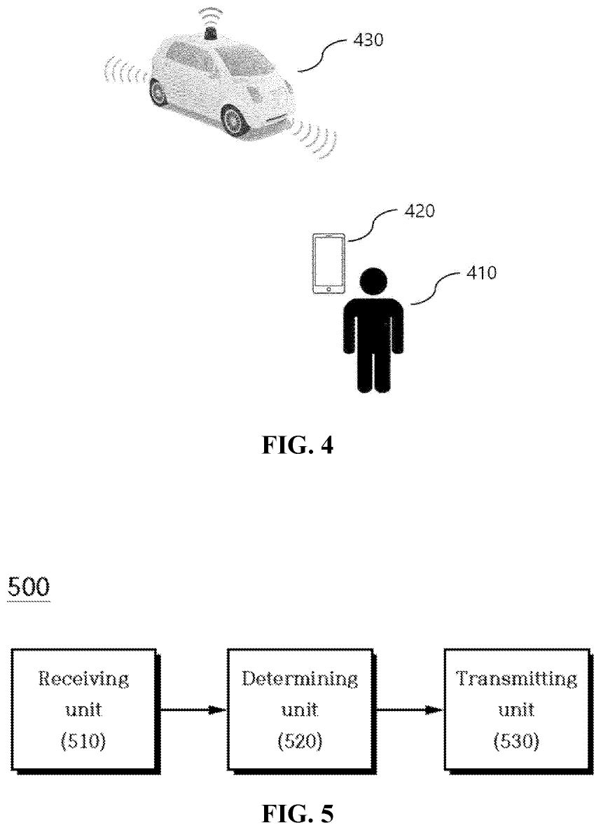

For example, referring to FIG. 4, the manager 410 may execute the camera application of the smart device 420. Thereafter, the manager 410 adjusts the location of the second autonomous mobile vehicle 430 to be shown in the camera application, and then selects the second autonomous mobile vehicle 430 on the camera application to calculate the location of the second autonomous mobile vehicle 430.

To be more specific, the camera application determines a coordinate of the manager 410 using the GPS sensor of the smart device 420, measures a direction of the smart device 420 using the compass sensor, and measures a distance from the smart device 420 to the second autonomous mobile vehicle 430 using the distance sensor, such as a ToF or a LiDAR to calculate the location (coordinate) of the second autonomous mobile vehicle 430.

Finally, in step S130, when the second autonomous mobile vehicle corresponds to the first autonomous mobile vehicle, the information sharing and controlling system transmits control information including information about the first autonomous mobile vehicle and information for controlling the first autonomous mobile vehicle to the external terminal.

That is, when the location of the second autonomous mobile vehicle is equal to the location of the first autonomous mobile vehicle within a predetermined error range, the information sharing and controlling system may determine that the second autonomous mobile vehicle is the first autonomous mobile vehicle. To this end, the information sharing and controlling system may periodically receive a current location of the first autonomous mobile vehicle or request the first autonomous mobile vehicle to transmit the current location.

In that case, the information sharing and controlling system may transmit the control information including information about the first autonomous mobile vehicle and information for controlling the first autonomous mobile vehicle to the external terminal.

At this time, the information about the first autonomous mobile vehicle may be a movement route, a current location, and operator information and the information for controlling the first autonomous mobile vehicle may be API information for controlling the first autonomous mobile vehicle to be operated, stop, or detour.

According to another exemplary embodiment, the external terminal may control the autonomous mobile vehicle while communicating with the first autonomous mobile vehicle using the control information.

For example, it is assumed that a manager who manages the apartment complex reviews the movement route included in the control information to determine that the autonomous mobile vehicle is passing through a no-passing area in the apartment complex. At this time, the manager may transmit a command to the first autonomous mobile vehicle using the API included in the control information to stop the operation or detour the no-passing area.

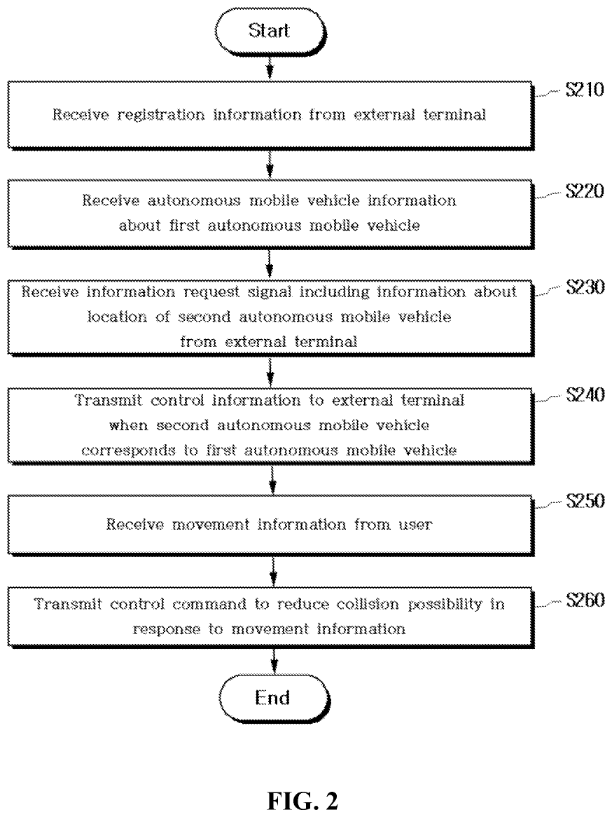

FIG. 2 is a flowchart for explaining an information sharing and controlling method of an autonomous mobile vehicle according to another exemplary embodiment of the present invention.

In step S210, the information sharing and controlling system receives registration information including information about a management area and a necessary authority from the external terminal.

For example, policemen, managers or users of specific facilities/complexes, and owners of private lands who operate the external terminal may register the external terminal in advance in the information sharing and controlling system to share and control the information of the autonomous mobile vehicle.

At this time, when the management area and the necessary authority included in the registration information are appropriate, the information sharing and controlling system may register the external terminal, the management area, and the authority in the database.

In step S220, the information sharing and controlling system receives autonomous mobile vehicle information including information about a first autonomous mobile vehicle which moves toward a destination and information about a movement route of the first autonomous mobile vehicle.

In step S230, the information sharing and controlling system receives an information request signal which includes information about a location of the second autonomous mobile vehicle and requests information of the second autonomous mobile vehicle, from the external terminal.

In step S240, when the second autonomous mobile vehicle corresponds to the first autonomous mobile vehicle, the information sharing and controlling system transmits control information including information about the first autonomous mobile vehicle and information for controlling the first autonomous mobile vehicle to the external terminal.

At this time, when both the locations of the first and second autonomous mobile vehicles are within a predetermined error range from the management area, the information sharing and controlling system determines that the second autonomous mobile vehicle is equal to the first autonomous mobile vehicle to transmit the control information to the external terminal.

Further, only when the authority of the external terminal which is registered in the database is appropriate, the information sharing and controlling system may transmit the control information to the external terminal.

In step S250, the information sharing and controlling system receives movement information including information of a movement route, a current location, and a speed from a predetermined user.

For example, the information sharing and controlling system may receive movement information including information of a movement route, a current location, and a speed of the user from a smart phone application of the user who jogs in the apartment complex. At this time, the smart phone application may be a separately produced application.

Finally, in step S260, the information sharing and controlling system transmits a control command which is a command of controlling the first autonomous mobile vehicle to reduce a collision possibility of the user and the first autonomous mobile vehicle information in response to the movement information.

That is, the information sharing and controlling system calculates a possibility that the first autonomous mobile vehicle and the user collide or come close within a predetermined range, using a movement route, a current location, and a speed of the user together with the movement route, the current location, and the speed of the first autonomous mobile vehicle and transmits a control command to cause the first autonomous mobile vehicle to temporarily stop or detour.

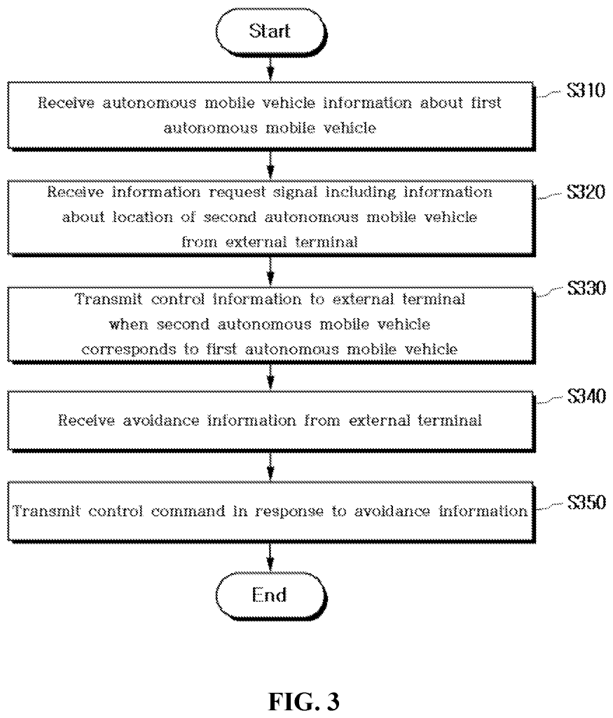

FIG. 3 is a flowchart for explaining an information sharing and controlling method of an autonomous mobile vehicle according to still another exemplary embodiment of the present invention.

In step S310, an information sharing and controlling system receives autonomous mobile vehicle information including information about a first autonomous mobile vehicle which moves toward a destination and information about a movement route of the first autonomous mobile vehicle.

In step S320, the information sharing and controlling system receives an information request signal which includes information about a location of the second autonomous mobile vehicle and requests information of the second autonomous mobile vehicle, from the external terminal.

In step S330, when the second autonomous mobile vehicle corresponds to the first autonomous mobile vehicle, the information sharing and controlling system transmits control information including information about the first autonomous mobile vehicle and information for controlling the first autonomous mobile vehicle to the external terminal.

In step S340, the information sharing and controlling system receives avoidance information including information about an avoidance area that the first autonomous mobile vehicle must avoid from the external terminal.

For example, the avoidance area may be construction areas set by the manager who manages the apartment complex, a no-passing area which is set by the police for security reasons, or the like.

At this time, the avoidance area may be set by receiving one, two or more points through the smart phone application. To be more specific, when one point is received, the avoidance area may include an area to a predetermined distance range from the point and when two points are received, the avoidance area may include an area to a predetermined distance range from a line that connects the two points. When two or more points are received, the avoidance area may include a polygonal area configured by the points.

Further, at the received point, a structure (for example, a light stick or a warning light) which can be recognized by the human, or the autonomous mobile vehicle is located to prevent accidents that the human or the autonomous mobile vehicle enters the avoidance area.

Finally, in step S340, the information sharing and controlling system transmits a control command to control the first autonomous mobile vehicle to avoid the avoidance area.

That is, when it is determined that the first autonomous mobile vehicle enters the avoidance area using the movement route of the first autonomous mobile vehicle, the information sharing and controlling system may transmit a control command to cause the first autonomous mobile vehicle to detour.

FIG. 5 is a block diagram illustrating an information sharing and controlling system of an autonomous mobile vehicle according to an exemplary embodiment of the present invention.

Referring to FIG. 5, the information sharing and controlling system 500 of the autonomous mobile vehicle according to the exemplary embodiment of the present invention includes a receiving unit 510, a determining unit 520, and a transmitting unit 530.

In the meantime, the information sharing and controlling system 500 of the autonomous mobile vehicle may be mounted in a computing device, such as a server computer, a notebook computer, or a desktop computer.

The receiving unit 510 receives autonomous mobile vehicle information including information about a first autonomous mobile vehicle which moves toward a destination and information about a movement route of the first autonomous mobile vehicle and receives an information request signal which includes information about the location of the second autonomous mobile vehicle and requests information of the second autonomous mobile vehicle from the external terminal.

According to another exemplary embodiment, when the external terminal is a portable smart device, the external terminal calculates the location of the second autonomous mobile vehicle displayed on a camera application to generate the information request signal.

The determining unit 520 determines whether the second autonomous mobile vehicle corresponds to the first autonomous mobile vehicle.

Finally, when the second autonomous mobile vehicle corresponds to the first autonomous mobile vehicle, the transmitting unit 530 transmits control information including information about the first autonomous mobile vehicle and information for controlling the first autonomous mobile vehicle to the external terminal.

According to another exemplary embodiment, the external terminal may control the first autonomous mobile vehicle while communicating with the first autonomous mobile vehicle using the control information.

According to still another exemplary embodiment, the receiving unit 510 further receives registration information including information about a management area and a necessary authority from the external terminal and the determining unit 520 compares the location of the first autonomous mobile vehicle and the location of the second autonomous mobile vehicle to determine whether the second autonomous mobile vehicle corresponds to the first autonomous mobile vehicle.

It will be appreciated that various exemplary embodiments of the present invention have been described herein for purposes of illustration, and that various modifications, changes, and substitutions may be made by those skilled in the art without departing from the scope and spirit of the present invention. Accordingly, the exemplary embodiments carried out in the present invention are intended to not limit but describe the technical spirit of the present invention and the scope of the technical spirit of the present invention is not restricted by the exemplary embodiments. The protective scope of the present invention should be construed based on the following claims, and all the technical concepts in the equivalent scope thereof should be construed as falling within the scope of the present invention.

1. An information sharing and controlling method of an autonomous mobile vehicle, comprising:
receiving autonomous mobile vehicle information including information about a first autonomous mobile vehicle which moves toward a destination and information about a movement route of the first autonomous mobile vehicle;
receiving an information request signal which includes information about a location of a second autonomous mobile vehicle and requests information of the second autonomous mobile vehicle from an external terminal; and
transmitting control information including the information about the first autonomous mobile vehicle and information for controlling the first autonomous mobile vehicle to the external terminal when the second autonomous mobile vehicle corresponds to the first autonomous mobile vehicle.

2. The information sharing and controlling method of an autonomous mobile vehicle of claim 1, wherein the external terminal controls the first autonomous mobile vehicle while communicating with the first autonomous mobile vehicle using the control information.

3. The information sharing and controlling method of an autonomous mobile vehicle of claim 1, wherein when the external terminal is a portable smart device, the external terminal calculates the location of the second autonomous mobile vehicle displayed on a camera application to generate the information request signal.

4. The information sharing and controlling method of an autonomous mobile vehicle of claim 1, further comprising:
before the receiving of the information request signal,
receiving registration information including information about a management area and a necessary authority from the external terminal,
wherein in the transmitting of control information, the management area, a location of the first autonomous mobile vehicle, and the location of the second autonomous mobile vehicle are compared to determine whether the second autonomous mobile vehicle corresponds to the first autonomous mobile vehicle.

5. The information sharing and controlling method of an autonomous mobile vehicle of claim 1, wherein the autonomous mobile vehicle information includes the movement route, a current location, operator information, and information for controlling an operation of the first autonomous mobile vehicle.

6. The information sharing and controlling method of an autonomous mobile vehicle of claim 1, further comprising:
receiving movement information including information of a movement route, a current location, and a speed from a predetermined user; and
transmitting a control command to control the first autonomous mobile vehicle to reduce a collision possibility of the user and the first autonomous mobile vehicle information in response to the movement information.

7. The information sharing and controlling method of an autonomous mobile vehicle of claim 1, further comprising:
receiving avoidance information including information about an avoidance area that the first autonomous mobile vehicle must avoid, from the external terminal; and
transmitting a control command to control the first autonomous mobile vehicle to avoid the avoidance area in response to the avoidance information.

8. An information sharing and controlling system of an autonomous mobile vehicle, comprising:
a receiving unit which receives autonomous mobile vehicle information including information about a first autonomous mobile vehicle which moves toward a destination and information about a movement route of the first autonomous mobile vehicle and receives an information request signal which includes information about a location of a second autonomous mobile vehicle and requests information of the second autonomous mobile vehicle from an external terminal;
a determining unit which determines whether the second autonomous mobile vehicle corresponds to the first autonomous mobile vehicle; and
a transmitting unit which transmits control information including the information about the first autonomous mobile vehicle and information for controlling the first autonomous mobile vehicle to the external terminal when the second autonomous mobile vehicle corresponds to the first autonomous mobile vehicle.

9. The information sharing and controlling system of an autonomous mobile vehicle of claim 8, wherein the external terminal controls the first autonomous mobile vehicle while communicating with the first autonomous mobile vehicle using the control information.

10. The information sharing and controlling system of an autonomous mobile vehicle of claim 8, wherein when the external terminal is a portable smart device, the external terminal calculates the location of the second autonomous mobile vehicle displayed on a camera application to generate the information request signal.
